(19) United States
(12) Patent Application Publication
(10) Pub. No.: US 2011/0299808 A1
(43) Pub. Date: Dec. 8, 2011

(54) Optical Waveguide and Optical Waveguide Module

(76) Inventors: Yasunobu Matsuoka, Hachioji (JP); Toshiki Sugawara, Kokubunji (JP)

(21) Appl. No.: 13/201,272

(22) PCT Filed: Jan. 29, 2010
(86) PCT No.: PCT/JP2010/051222

§ 371 Date: Aug. 12, 2011

(30) Foreign Application Priority Data
Feb. 25, 2009 (JP) 2009-042670

(51) Int. Cl. G02B 6/32; G02B 6/26

(52) U.S. Cl. 385/14; 385/31

(57) ABSTRACT

An optical waveguide module which satisfies highly-accurate and stable optical connection between optical elements and optical waveguides and can be easily fabricated is provided. As means for it, in an optical waveguide module having: an optical waveguide surrounded by a cladding layer and provided with a mirror part formed of a tapered surface on a first end side; an optical element having a concave part in a first surface of a semiconductor substrate; and a convex member provided on the cladding layer so as to be planarly overlapped with the mirror part, the convex member is mated with the concave part of the optical element.

### TECHNICAL FIELD

The present invention relates to an optical waveguide and an optical waveguide module and more particularly relates to the techniques effectively applied to an optical waveguide module serving as a terminal in the transmission of high-speed optical signals which are transmitted/received between chips or boards with using optical waveguides as wiring media between devices or in a device such as a data processing device.

### BACKGROUND ART

Recently, in the field of information and telecommunications, the communication traffic for transmitting/receiving large-volume data at high speed by using light has been rapidly developing, and fiber-optic networks have been expanded for comparatively long distances of several km or more such as a backbone network, metro network and access network. In the future, further changing of signal wiring to optical wiring is effective also for the extremely short distances such as a rack-to-rack distance (several cm to several hundreds of m) and an intra-rack distance (several cm to several tens of cm) in order to process large-volume data without delay.

Regarding the change of rack-to-rack/intra-rack wiring to optical wiring, for example, in a transmission device such as a router/switch, high-frequency signals transmitted from outside by Ethernet or the like through optical fibers are input to line cards. The several line cards are organized for one backplane, the signals input to the line cards are further collected to a switch card via the backplane, processed by LSI in the switch card, and then output to the line cards again via the backplane. Herein, in a current device, signals of 300 Gbt/s or more are collected to the switch card from the line cards via the backplane. In order to transmit them by current electric wiring, the signals have to be divided to about 1 to 3 Gbit/s per one line due to propagation loss, and therefore, 100 or more lines are required.

Furthermore, with respect to these high-frequency lines, countermeasures against pre-emphasis/equalizers, reflection, or crosstalk between the lines are required. When increase in the capacity of systems is further advanced in the future, in the case of a device which processes information of Tbit/s or more, the problems of the number of lines, crosstalk countermeasures, and others will become more and more serious in conventional electric wiring. For the solution thereof, it is promising to change the signal transmission lines between the intra-rack boards of the line cards, the backplane, and the switch card and between chips in the boards to optical lines since the number of required lines can be reduced because high-frequency signals of 10 Gbps or higher can be propagated with low loss, and the need of the above-described countermeasures is eliminated even for high-frequency signals. Moreover, it is effective to change signal transmission lines to optical lines also in video equipment such as video cameras and commercial equipment such as PCs and mobile phones other than the above-described router/switch since increase in the speed/capacity of video signal transmission between monitors and terminals is required in the implementation of high-definition images in the future, and the problems such as countermeasures against signal delay and noise become notable in conventional electric wiring.

In order to realize such a high-speed optical interconnection circuit and apply that to rack-to-rack/intra-rack systems, optical modules and circuits excellent in terms of performance, downsizing/integration, and component mounting characteristics with low-cost fabrication means are required. Therefore, a reduced-size high-speed plane type optical waveguide module in which optical waveguides which have lower cost and are advantageous for density increase compared with conventional optical fibers are used as wiring media and optical components and the optical waveguides are integrated on a substrate has been proposed.

As an example of the conventional system of the plane type optical waveguide module, FIG. 8 shows a basic configuration of a PLC (Planar Lightwave Circuit) module in which optical components such as optical elements and an optical waveguide are disposed on the same substrate. In this system, optical components such as optical elements 101 and 103 (for example, 101 is LD: Laser Diode, 103 is PD: Photo Diode) and a filter 102 can be integrated on the same platform substrate 100. Therefore, the number of components can be reduced, and the module can be downsized. In FIG. 8, the optical waveguide 104 and an optical fiber 105 are disposed on the platform substrate 100. Since the optical axis alignment thereof is a passive alignment method in which the alignment is carried out at the same time as mounting the optical components onto the platform substrate 100, the module can be fabricated by a small number of mounting man-hours.

Furthermore, as another example of the conventional system of the plane type optical waveguide module, Patent Document 1 discloses a module type in which optical connection is carried out by mounting a separate film optical waveguide array to an optical element array mounted on a substrate. In this example, concave and convex parts are provided for the film-shaped optical waveguides by using a transfer substrate, and the positions of the optical waveguides are fixed by concave/convex mating with respect to a support provided on an element mounting substrate, thereby optically coupling the optical waveguides and optical elements. As a result, the fabrication process thereof is simplified, and the cost of the optical module can be reduced.

### PRIOR ART DOCUMENTS

### Patent Documents

Patent Document 1: Japanese Unexamined Patent Application Publication No. 2005-292379

### SUMMARY OF THE INVENTION

### Problems to be Solved by the Invention

The PLC module shown in FIG. 8 which is an example of the conventional system of the plane type optical waveguide module employs a passive alignment method in which the axes of optical elements are adjusted only by the positional accuracy of mounting of the components while monitoring alignment marks or the like provided on the platform substrate 100, and optical connection in minute regions between the end faces of the optical elements and optical waveguide end faces is required. Therefore, the mounting allowance for satisfying the positioning accuracy of the optical components at the same time is small, and it is difficult to ensure good optical performance. Furthermore, in the case in which multiple channels of the optical elements and the optical waveguides are to be implemented, it is further difficult to ensure the fabrication yield for obtaining stable optical connection.

On the other hand, the plane type optical waveguide module disclosed in Patent Document 1 also employs a passive mounting method in which the separate film optical waveguide array is mated by concave/convex parts to the support of the element mounting substrate so as to optically connect it to the optical element array, and although the fabrication process is simplified, there is a limit for increasing accuracy because the positioning accuracy for obtaining stable optical connection depends on the fabrication accuracy of the optical components and the mounting accuracy of the components. In particular, in order to satisfy highly-efficient optical connection between a minute optical line such as a single-mode optical waveguide having a core diameter of several μm and an optical element, mounting accuracy of around 1-μm order is required, and the required accuracy becomes stricter in the case of formation of an array.

Therefore, an object of the present invention is to provide an optical waveguide module which satisfies highly-accurate and stable optical connection between optical elements and optical waveguides and can be simply fabricated.

### Means for Solving the Problems

The following is a brief description of an outline of the typical invention disclosed in the present application.

(1) An optical waveguide having a core layer surrounded by a cladding layer, provided with a mirror part formed of a tapered surface on a first end side, and transmitting light when an optical element is mounted includes: a convex member provided on the cladding layer so as to be planarly overlapped with the mirror part, and the convex member has a shape capable of being mated with a concave part of an optical element when the optical element having the concave part is mounted on a first surface of a semiconductor substrate.

(2) In (1) described above, the optical waveguide is made of polymer.

(3) In (2) described above, the convex member is made of a material similar to that of the core layer.

(4) An optical waveguide module according to the present invention includes: an optical waveguide surrounded by a cladding layer and provided with a mirror part formed of a tapered surface on a first end side; an optical element having a concave part in a first surface of a semiconductor substrate; and a convex member provided on the cladding layer so as to be planarly overlapped with the mirror part, and the convex member is mated with the concave part of the optical element.

(5) An optical waveguide module according to the present invention includes: a plurality of optical waveguides each surrounded by a cladding layer and provided with a mirror part formed of a tapered surface on a first end side, the optical waveguides being disposed in parallel to each other; an optical element array having a plurality of optical elements each having concave parts in a first surface of a semiconductor substrate and formed on the semiconductor substrate so as to correspond to the mirror parts of the plurality of optical waveguides; and two convex members provided on the cladding layer so as to be planarly overlapped with each of the mirror parts of at least two of the optical waveguides among the plurality of optical waveguides, and the two convex members are mated with the concave parts of the at least two optical elements among the plurality of optical elements.

(6) In (4) or (5) described above, the convex member has a convex lens function.

(7) In (6) described above, the optical element has a lens at a bottom surface of the concave part, and the lens is distant from the convex member.

(8) In (4) or (5) described above, the optical element is a laser diode having a lens provided at a bottom surface of the concave part and a light emitting part provided on a second surface side opposite to the first surface of the semiconductor substrate so as to be opposed to the lens.

(9) In (4) or (5) described above, the optical element is a photo diode having a lens provided at a bottom surface of the concave part and a light receiving part provided on a second surface side opposite to the first surface of the semiconductor substrate so as to be opposed to the lens.

(10) In (5) described above, the number of the plurality of optical waveguides is three or more, and at least one or more of the optical waveguides are disposed between two of the optical waveguides corresponding to the two convex members.

(11) In (5) described above, the number of the plurality of optical waveguides is three or more, and the two convex members correspond to the mirror parts of the two optical waveguides positioned on both sides of an array made up of the three or more optical waveguides.

(12) An optical waveguide module according to the present invention includes: an optical waveguide surrounded by a cladding layer and provided with mirror parts each formed of a tapered surface on a first end side and a second end side, respectively; a laser diode having a first concave part; a photo diode having a second concave part; a first convex member provided on the cladding layer so as to be planarly overlapped with the mirror part on the first end side of the optical waveguide; and a second convex member provided on the cladding layer so as to be planarly overlapped with the mirror part on the second end side of the optical waveguide, and the first convex member is mated with the first concave part of the laser diode, and the second convex member is mated with the second concave part of the photo diode.

(13) In (12) described above, each of the first and second convex members has a convex lens function.

(14) In (12) described above, the laser diode and the photo diode have lenses at bottom surfaces of the concave parts, respectively, and the lens is distant from the convex member.

### Effects of the Invention

The effects obtained by typical embodiments of the invention disclosed in the present application will be briefly described below.

According to the present invention, the convex member having the convex step is provided so as to be planarly overlapped with the mirror part of the waveguide, the optical element is provided with the concave part, and the convex member and the concave part are mated with each other, thereby easily realizing highly-accurate mounting of elements. Since highly accurate mounting can be achieved, the element and the waveguide can be coupled to each other with low loss. Therefore, the optical waveguide module capable of realizing efficient high-quality optical transmission with small power consumption can be provided.

Furthermore, when the convex step is formed from a material similar to that of the core layer of the optical waveguide, the convex step can be formed by photolithography patterning in the manufacturing process of the optical waveguide. Since this can be formed by a continuous process, in addition to achieving the short-time manufacturing, the positional misalignment with respect to the core layer of the optical waveguide can be reduced compared with the positional misalignment of the case in which a separate member is mounted. Accordingly, the optical waveguide having high coupling efficiency with respect to the optical element can be formed.

### BRIEF DESCRIPTIONS OF THE DRAWINGS

FIG. 1A is a perspective view showing a schematic configuration of the optical waveguide module according to the first embodiment of the present invention;

FIG. 1B is a plan view showing the schematic configuration of the optical waveguide module according to the first embodiment of the present invention;

FIG. 1C is a cross-sectional view showing the cross-sectional structure taken along the A-A line of FIG. 1B;

FIG. 1D is a cross-sectional view showing the cross-sectional structure taken along the B-B line of FIG. 1B;

FIG. 1E is a cross-sectional view showing the state in which optical elements (laser diodes and photo diodes) are omitted in FIG. 1C;

FIG. 2A is a cross-sectional view showing a manufacturing step of a laser diode array incorporated in the optical waveguide module according to the first embodiment of the present invention (state in which an epitaxial layer is formed on a semiconductor substrate);

FIG. 2B is a cross-sectional view showing a manufacturing step of the laser diode array subsequent to FIG. 2A (state in which light emitting parts are formed by subjecting the epitaxial layer to a processing);

FIG. 2C is a cross-sectional view showing a manufacturing step of the laser diode array subsequent to FIG. 2B (state in which passivation is patterned and formed on the surface of the semiconductor substrate that is on the opposite side of the epitaxial layer);

FIG. 2D is a cross-sectional view showing a manufacturing step of the laser diode array subsequent to FIG. 2C (state in which lenses are formed on the semiconductor substrate);

FIG. 3A is a cross-sectional view showing a manufacturing step of an optical waveguide substrate incorporated in the optical waveguide module according to the first embodiment of the present invention (state in which a cladding layer is formed on the substrate);

FIG. 3B is a cross-sectional view showing a manufacturing step of the optical waveguide substrate subsequent to FIG. 3A (state in which core patterns are formed on the cladding layer);

FIG. 3C is a cross-sectional view showing a manufacturing step of the optical waveguide substrate subsequent to FIG. 3B (state in which taper-shaped mirrors (reflecting mirrors) are formed at both end parts of the core patterns);

FIG. 3D is a cross-sectional view showing a manufacturing step of the optical waveguide substrate subsequent to FIG. 3C (state in which the core patterns are covered with a cladding layer);

FIG. 4 is a cross-sectional view showing part of an optical waveguide module, which is a modification example of the first embodiment of the present invention, so as to correspond to the part of FIG. 1C;

FIG. 5A is a plan view showing an optical waveguide module according to the second embodiment of the present invention;

FIG. 5B is a cross-sectional view showing the cross-sectional structure taken along the C-C line of FIG. 5A;

FIG. 5C is a cross-sectional view showing the cross-sectional structure taken along the D-D line of FIG. 5A;

FIG. 6A is a cross-sectional view of an optical waveguide module according to the third embodiment of the present invention;

FIG. 6B is a cross-sectional view showing the state in which optical elements (laser diodes and photo diodes) in FIG. 6A are omitted;

FIG. 7 is a drawing showing an overview of a fourth embodiment in which the optical waveguide modules of the present invention are applied; and

FIG. 8 is a drawing showing a basic configuration of a PLC module, which is an example of a conventional system of an optical waveguide module.

### BEST MODE FOR CARRYING OUT THE INVENTION

Hereinafter, embodiments of the present invention will be described in detail with reference to drawings.

### First Embodiment

In the present first embodiment, an example in which the present invention is applied to an optical waveguide module having: a laser diode array in which a plurality of laser diodes are disposed; a photo diode array in which a plurality of photo diodes are disposed; and an optical waveguide substrate on which a plurality of optical waveguides optically connecting them are disposed will be described.

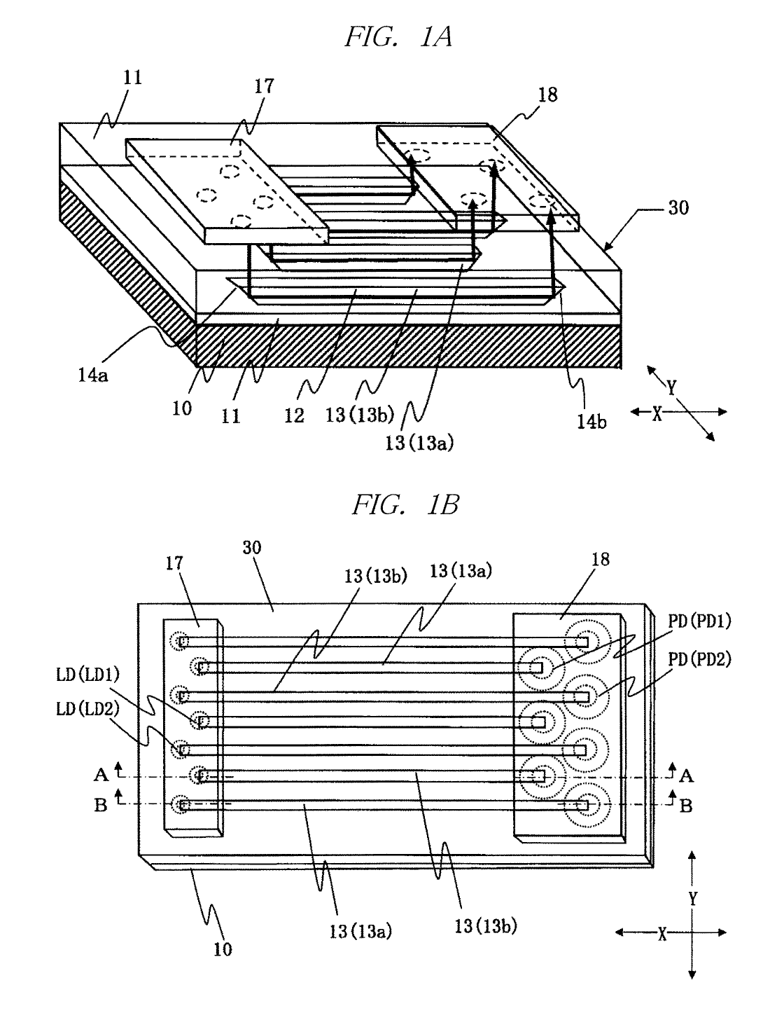

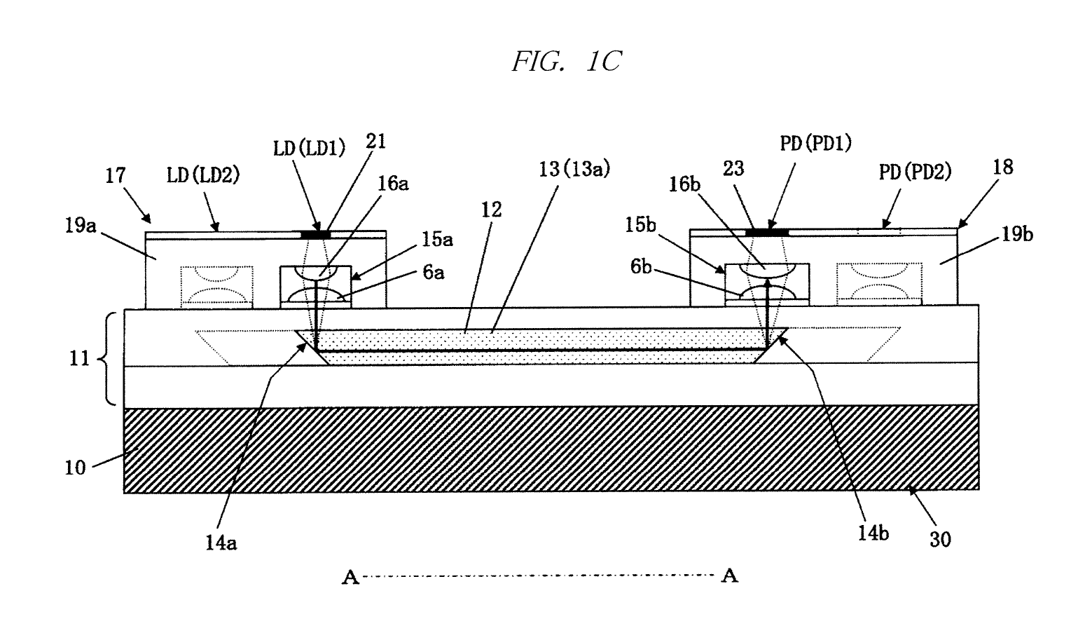

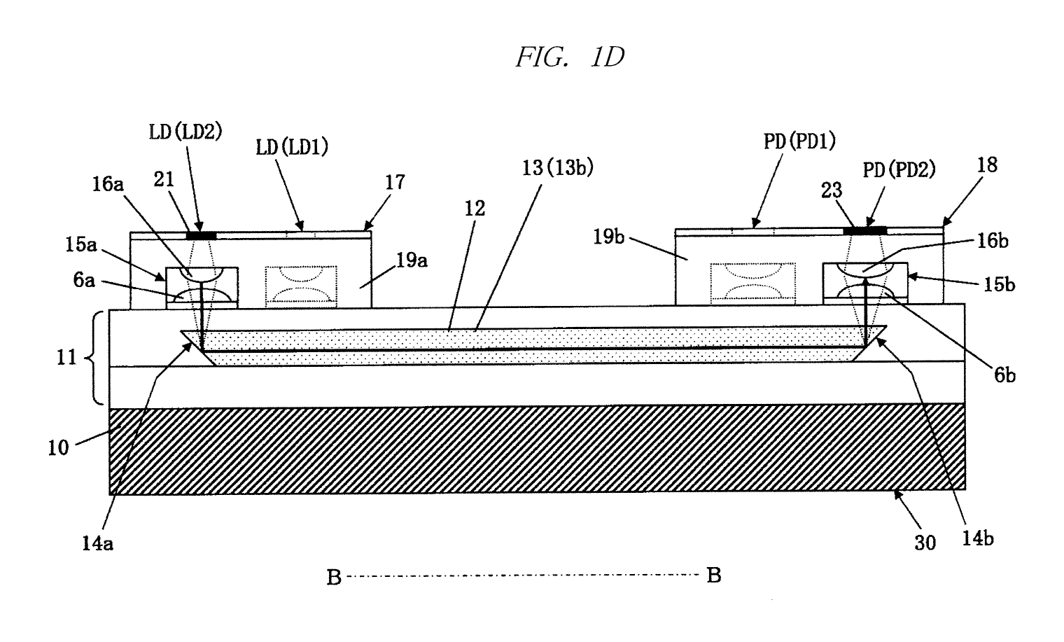

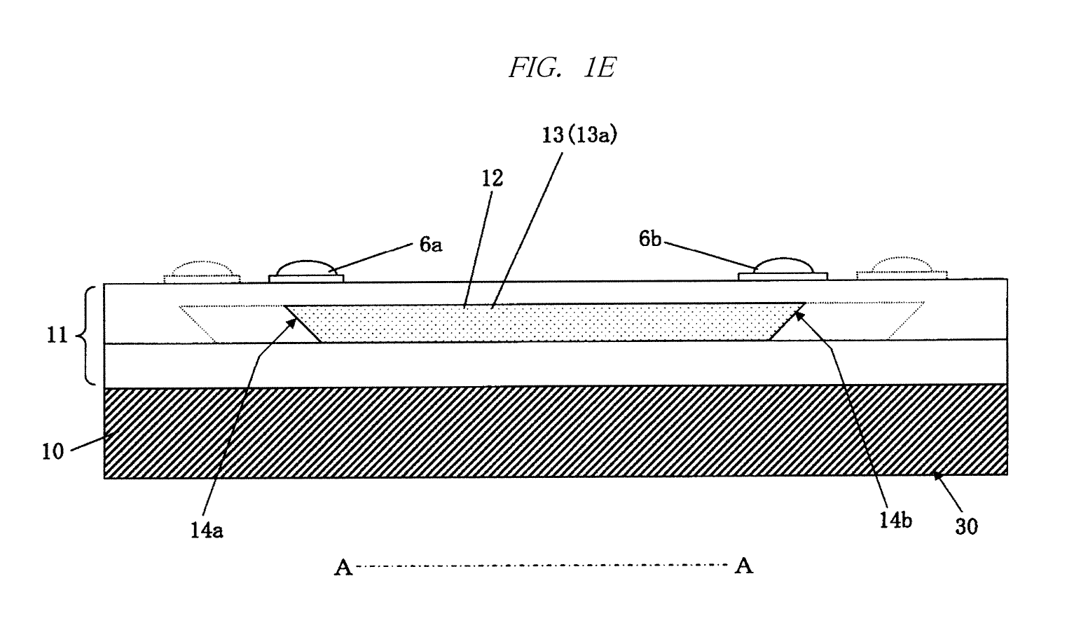

FIG. 1A to FIG. 1E are drawings relating to the optical waveguide module according to the first embodiment of the present invention, in which

FIG. 1A is a perspective view showing a schematic configuration of the optical waveguide module,

FIG. 1B is a plan view showing the schematic configuration of the optical waveguide module,

FIG. 1C is a cross-sectional view showing the cross-sectional structure taken along the A-A line of FIG. 1B,

FIG. 1D is a cross-sectional view showing the cross-sectional structure taken along the B-B line of FIG. 1B, and

FIG. 1E is a cross-sectional view showing the state in which optical elements (laser diodes and photo diodes) are omitted in FIG. 1C.

As shown in FIG. 1A to FIG. 1D, the optical waveguide module of the present first embodiment is provided with: for example, a laser diode array 17 and a photo diode array 18 serving as optical element arrays and an optical waveguide substrate 30 for optically connecting these optical element arrays to each other (between the laser diode array 17 and the photo diode array 18).

The optical waveguide substrate 30 has the optical waveguide arrays having a multiple channel structure made up of a plurality of optical waveguides 13 extending in a first direction (for example, X direction) on a substrate 10 and disposed in parallel in a second direction (for example, Y direction) orthogonal to the first direction in the same plane. The substrate 10 is made of a material such as glass epoxy, ceramic, or semiconductor. Each of the plurality of optical waveguides 13 is surrounded by a cladding layer 11 provided on the substrate 10 and is formed of a core 12 made of a material having a refractive index higher than that of the cladding layer 11. Each of the plurality of optical waveguides 13 has mirror parts (reflecting mirrors) 14a and 14b, each of which is formed of a tapered surface for converting the optical path of propagated light to the direction approximately perpendicular to the extending direction of the optical waveguide 13, at a first end side and a second end side positioned on the mutually opposite sides. The mirror part 14a of the first end side is formed to have an angle of approximately 45 degrees anticlockwise with respect to the thickness direction of the cladding layer 11 or the substrate 10, and the mirror part 14b of the second end side is formed to have an angle of approximately 45 degrees clockwise with respect to the thickness direction of the cladding layer 11 or the substrate 10.

In the present embodiment, the plurality of optical waveguides include optical waveguides 13a (see FIG. 1C) and optical waveguides 13b (see FIG. 1D) whose optical path has a longer length than that of the optical waveguide 13a, and the optical waveguide 13a and the optical waveguide 13b are alternately and repeatedly disposed in the second direction. The optical waveguides 13a and 13b are disposed so that the mirror part 14a on the first end side of the optical waveguide 13a is positioned inside the mirror part 14a on the first end side of the optical waveguide 13b (on the mirror part 14b side on the second end side of the optical waveguide 13a) and the mirror part 14b on the second end side of the optical waveguide 13a is positioned inside the mirror part 14b on the second end side of the optical waveguide 13b (on the mirror part 14a side on the first end side of the optical waveguide 13a). In other words, in the optical waveguide arrays of the present embodiment, the mirror parts 14a on the one end side and the mirror parts 14b on the second end side of the plurality of optical waveguides 13 are disposed in a zigzag alignment in the second direction.

The laser diode array 17 has a plurality of laser diodes LD corresponding to the number of the optical waveguides 13, and each of the plurality of laser diodes LD is formed on, for example, one common semiconductor substrate 19a (see FIG. 1C and FIG. 1D). The plurality of laser diodes LD of the laser diode array 17 are disposed in a zigzag alignment so as to correspond to the zigzag alignment of the mirror parts 14a on the first end side of the plurality of optical waveguides 13 (see FIG. 1B).

The photo diode array 18 has a plurality of photo diodes PD corresponding to the number of the optical waveguides 13, and each of the plurality of photo diodes PD is formed on, for example, one common semiconductor substrate 19b (see FIG. 1C and FIG. 1D). The plurality of photo diodes PD of the photo diode array 18 are disposed in a zigzag alignment so as to correspond to the zigzag alignment of the mirror parts 14b on the second end side of the plurality of optical waveguides 13 (see FIG. 1B).

The laser diode array 17 is disposed on the cladding layer 11 so that the plurality of laser diodes LD thereof are planarly overlapped with, in other words, opposed to the mirror parts 14a on the first end side of the plurality of optical waveguides 13 (see FIG. 1C and FIG. 1D). The photo diode array 18 is disposed on the cladding layer 11 so that the plurality of photo diodes PD thereof are planarly overlapped with, in other words, opposed to the mirror parts 14b on the second end side of the plurality of optical waveguides 13 (see FIG. 1C and FIG. 1D).

Herein, the laser diode array 17 has the plurality of laser diodes LD disposed in the zigzag alignment corresponding to the zigzag alignment of the mirror parts 14a on the first end side of the plurality of optical waveguides 13. In other words, from the side close to the photo diode array 18, the laser diode array 17 has a laser diode LD1 of a first column and a laser diode LD2 of a second column, and the laser diode LD1 of the first column is disposed so as to correspond to the mirror part 14a on the first end side (inside the mirror part 14a on the first end side of the optical waveguide 13b) of the optical waveguide 13a among the plurality of optical waveguides 13, and the laser diode LD2 of the second column is disposed so as to correspond to the mirror part 14a on the first end side (outside the mirror part 14a on the first end side of the optical waveguide 13a) of the optical waveguide 13b among the plurality of optical waveguides 13 and to be displaced by a half pitch with respect to the laser diode LD1 of the first column.

Also, like the laser diode array 17, the photo diode array 18 has the plurality of photo diodes PD disposed in the zigzag alignment corresponding to the zigzag alignment of the mirror parts 14b on the second end side of the plurality of optical waveguides 13. In other words, from the side close to the laser diode array 17, the photo diode array 18 has a photo diode PD1 of a first column and a photo diode PD2 of a second column, and the photo diode PD1 of the first column is disposed so as to correspond to the mirror part 14b on the second end side (inside the mirror part 14b on the second end side of the optical waveguide 13b) of the optical waveguide 13a among the plurality of optical waveguides 13, and the photo diode PD2 of the second column is disposed so as to correspond to the mirror part 14b on the second end side (outside the mirror part 14b on the second end side of the optical waveguide 13a) of the optical waveguide 13b among the plurality of optical waveguides 13 and to be displaced by a half pitch with respect to the photo diode PD1 of the first column.

More specifically, in the optical waveguide module of the present embodiment, the laser diode LD1 of the first column (inside the second column) of the laser diode array 17 and the photo diode PD1 of the first column (inside the second column) of the photo diode array 18 are optically connected to each other (inside-inside optical connection) by the optical waveguide 13a whose optical path has a shorter length than that of the optical waveguide 13b, and the laser diode LD2 of the second column (outside the first column) of the laser diode array 17 and the photo diode PD2 of the second column (outside the first column) of the photo diode array 18 are optically connected to each other (outside-outside optical connection) by the optical waveguide 13b whose optical path is longer than that of the optical waveguide 13a.

Each of the plurality of laser diodes LD (see FIG. 1C and FIG. 1D) of the laser diode array 17 has a concave part 15a dented from a second surface of the semiconductor substrate 19a toward a first surface on the opposite side thereof, a lens 16a provided at a bottom surface of the concave part 15a, and a light emitting part 21 provided on the first surface side of the semiconductor substrate 19a so as to correspond to the lens 16a, and light is emitted from the light emitting part 21 in the direction perpendicular to the semiconductor substrate 19a (thickness direction of the semiconductor substrate 19a). More specifically, each of the laser diodes LD of the laser diode array 17 is made up of a surface emitting diode, which emits light in the direction perpendicular to the semiconductor substrate 19a.

Each of the plurality of photo diodes PD (see FIG. 1C and FIG. 1D) of the photo diode array 18 has a concave part 15b dented from a second surface of the semiconductor substrate 19b toward a first surface on the opposite side thereof, a lens 16b provided at a bottom surface of the concave part 15b, and a light receiving part 23 provided on the first surface side of the semiconductor substrate 19b so as to correspond to the lens 16b, and the light from the direction perpendicular to the semiconductor substrate 19b (thickness direction) is received by the light receiving part 23. More specifically, each of the photo diodes PD of the photo diode array 18 is made up of a surface receiving diode, which receives light in the direction perpendicular to the semiconductor substrate 19b.

An electrically-conductive layer, which is not shown in the drawings, is formed on the cladding layer 11 of the optical waveguide substrate 30. The laser diode array 17 is electrically and mechanically connected to the electrically-conductive layer on the cladding layer 11 via low-temperature solder and mounted on the optical waveguide substrate 30, with the lenses 16a and the light emitting parts 21 of the laser diodes LD thereof being opposed to the mirror parts 14a on the first end side of the optical waveguides 13. Similarly, the photo diode array 18 is also electrically and mechanically connected to the electrically-conductive layer on the cladding layer 11 via low-temperature solder and mounted on the optical waveguide substrate 30, with the lenses 16b and the light receiving parts 23 of the photo diodes PD thereof being opposed to the mirror parts 14b on the second side of the optical waveguides 13.

As shown in FIG. 1C to FIG. 1E, convex members 6a each having a convex step are formed on the cladding layer 11 of the optical waveguide substrate 30 so as to be planarly overlapped with, in other words, opposed to the mirror parts 14a on the first end side of the optical waveguides 13, respectively. Also, convex members 6b each having a convex step are formed on the cladding layer 11 of the optical waveguide substrate 30 so as to be planarly overlapped with the mirror parts 14b on the second side of the optical waveguides 13, respectively.

The convex members 6a can be mated with the concave parts 15a of the laser diodes LD, and when the concave part 15a of the laser diode LD and the convex member 6a of the optical waveguide substrate 30 are mated with each other, positioning of the mirror part 14a on the first end side of the optical waveguide 13 and the laser diode LD is carried out, and easy and highly-accurate mounting of the diode can be realized.

Similarly, the convex members 6b can also be mated with the concave parts 15b of the photo diodes PD, and when the concave part 15b of the photo diode PD and the convex member 6b of the optical waveguide substrate 30 are mated with each other, positioning of the mirror part 14b on the second end side of the optical waveguide 13 and the photo diode PD is carried out, and easy and highly-accurate mounting of the diode can be realized.

In the present embodiment, the convex members 6a and 6b are not limited to those and the plurality of convex members 6a and 6b are provided for the respective mirror parts on the first end side and the second end side (14a, 14b) of the plurality of optical waveguides 13. In other words, the plurality of convex members 6a are provided so as to correspond to the number of the laser diodes LD of the laser diode array 17, and the plurality of convex members 6b are provided so as to correspond to the number of the photo diodes PD of the photo diode array 18.

The convex members 6a and 6b are made of a material such as an optical transparency resin having a transmittance of at least 10% or more with respect to the optical emission wavelength of the laser diodes LD. Furthermore, the steps of the convex members can be made of the same material as that of a core layer of the optical waveguides. In this case, the steps can be formed by patterning of photolithography in a manufacturing process of the optical waveguides. Since this can be formed by a continuous process, in addition to achieving the short-time manufacturing, the positional misalignment with respect to the core layer of the optical waveguide can be reduced compared with the positional misalignment of the case in which a separate member is mounted. Accordingly, the optical waveguide having high coupling efficiency with respect to the optical element can be formed.

In the present embodiment, each of the convex members 6a and 6b has a convex lens function. Since each of the convex members 6a and 6b has the convex lens function, the lens 16a of the laser diode LD and the convex member 6a of the optical waveguide substrate 30 constitute a two-lens optical system, and the lens 16b of the photo diode PD and the convex member 6b of the optical waveguide substrate 30 constitute a two-lens optical system. Since diffusion of light can be suppressed in the two-lens optical system, a lateral displacement margin of the optical element (laser diode LD or photo diode PD) with respect to the plane direction of the optical waveguide substrate 30 can be ensured, which is effective for passive optical element mounting.

The convex member 6a is mated with the concave part 15a of the laser diode LD, and in this state, the convex member 6a is distant from the lens 16a in the concave part 15a. More specifically, in order to avoid contact with the lens 16a in the concave part 15a, the convex member 6a is formed to have a height smaller than the depth from the mounting surface on concave part 15a side of the laser diode LD to the lens 16a in the concave part 15a.

The convex member 6b is mated with the concave part 15b of the photo diode PD, and in this state, the convex member 6b is distant from the lens 16b in the concave part 15b. More specifically, in order to avoid contact with the lens 16b in the concave part 15b, the convex member 6b is formed to have a height smaller than the depth from the mounting surface on the concave part 15b side of the photo diode PD to the lens 16b in the concave part 15b.

Each of the concave parts (15a, 15b) of the laser diodes LD and the photo diodes PD is formed to have a circular shape as a planar shape thereof, and accordingly, each of the convex members (6a, 6b) is also formed to have a circular shape as a planar shape thereof. When such a structure is employed, mating between the concave parts (15a, 15b) of the optical elements (laser diodes LD, photo diodes PD) and the convex members (6a, 6b) is facilitated compared with the case in which the plane is quadrangular. Therefore, positioning of the optical elements (laser diodes LD, photo diodes PD) with respect to the mirror parts (14a, 14b) of the optical waveguides 13 can be easily carried out.

In the optical waveguide module of the present embodiment, an optical signal emitted from the laser diode LD in the direction perpendicular to the substrate is focused by the lens 16a formed in the semiconductor substrate 19a, is focused by the convex member 6a having the convex lens function, is subjected to optical path conversion in the direction horizontal to the substrate via the mirror part 14a of the optical waveguide 13, and is propagated in the optical waveguide 13. Thereafter, the optical signal is subjected to optical path conversion again in the direction perpendicular to the substrate by the mirror part 14b, is focused by the convex member 6b having the convex lens function, and then emitted therefrom. The emitted optical signal is focused by the lens 16b formed in the semiconductor substrate 19b, is then subjected to photoelectric conversion in the photo diode PD, and is output as an electric signal.

In this manner, the plurality of laser diodes LD of the laser diode array 17 and the plurality of optical waveguides 13 of the optical waveguide array can be optically connected to each other densely with low loss via the lenses 16a formed in the semiconductor substrate 19a, the convex members 6a having the convex lens function, and the mirror parts 14a formed on the first end side of the optical waveguides 13, and the plurality of photo diodes PD of the photo diode array 18 and the plurality of optical waveguides 13 of the optical waveguide array can be optically connected to each other densely with low loss via the lenses 16b formed in the semiconductor substrate 19b, the convex members 6b having the convex lens function, and the mirror parts 14b formed on the second end side of the optical waveguides 13.

Furthermore, the lenses 16a and 16b are integrally formed with the respective semiconductor substrates (19a, 19b) of the laser diode array 17 and the photo diode array 18, and the mirror parts 14a and 14b and the convex members 6a and 6b having the convex lens function are formed at both ends of the optical waveguides 13. Therefore, optical components need not to be mounted between the optical waveguides and the optical elements, and thus, the optical waveguide module can be fabricated with a small number of parts or fabrication processes.

Next, a fabrication method of the constituent parts of the optical waveguide module according to the first embodiment of the present invention will be simply described.

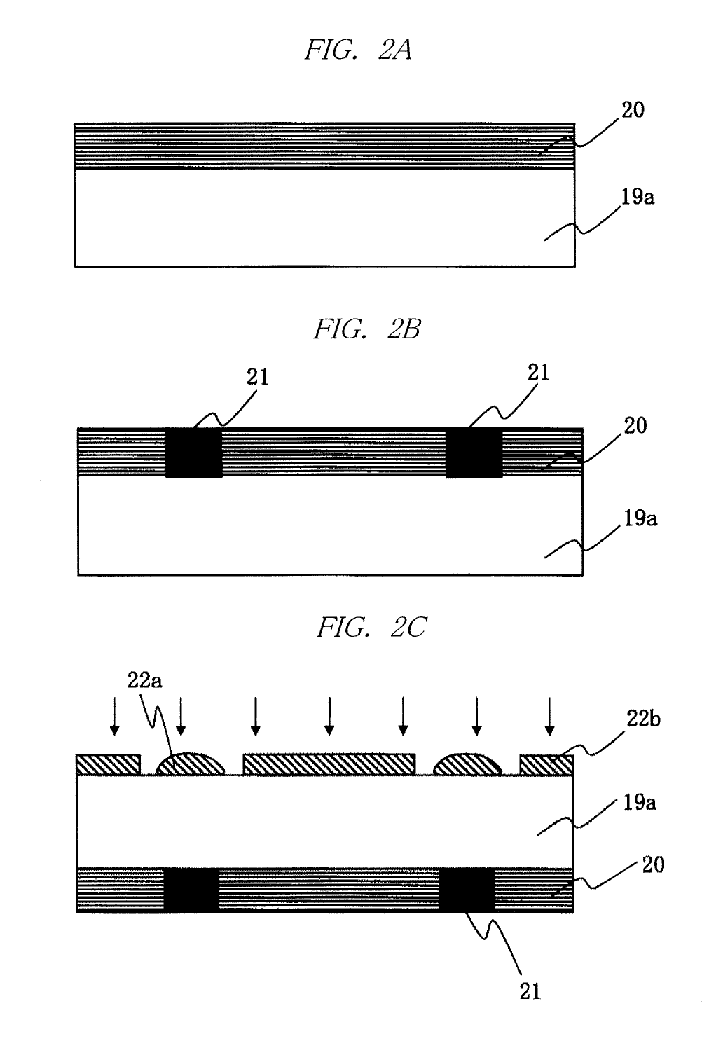

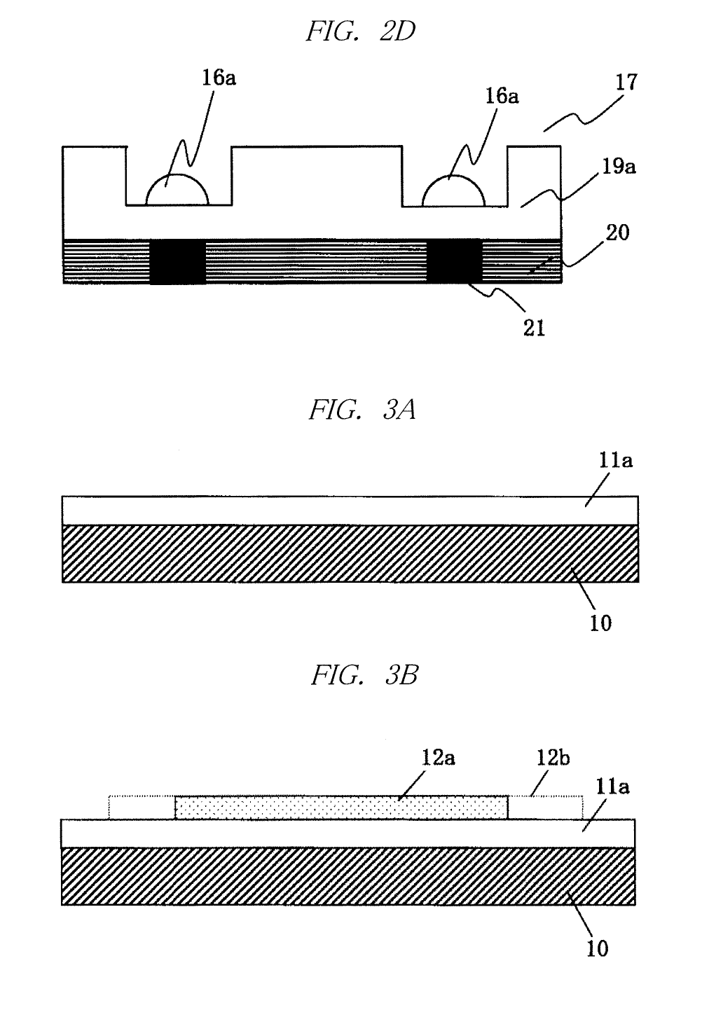

FIG. 2A to FIG. 2D are cross-sectional views showing manufacturing step of the laser diode array incorporated in the optical waveguide module according to the first embodiment of the present invention (drawings describing an example of a fabrication procedure of the laser diode array 17). The present invention can be applied to both of a single element and an array element, and the fabrication procedure is the same in both cases. The drawings used in the description herein show the case of the array element.

FIG. 2A is a drawing showing the state in which an epitaxial layer 20 is formed on the semiconductor substrate 19a. Examples of the material of the semiconductor substrate 19a include gallium arsenide (GaAs) and indium phosphide (InP) which are generally used in optical elements of compound semiconductors. However, as described above, a material transparent with respect to the optical emission wavelength is desirable so that loss is not increased when light passes through the interior of the semiconductor substrate 19a.

Next, as shown in FIG. 2B, the light emitting parts 21 are formed by subjecting the epitaxial layer 20 to such processes as photolithography and etching. Detailed fabrication methods are not particularly described, but mirror structures and others are provided in the light emitting parts 21 or in the vicinity thereof so that the light from the light emitting parts 21 is emitted in the direction of the semiconductor substrate 19a.

Next, as shown in FIG. 2C, passivations 22a and 22b are patterned and formed by lithography on the surface of the semiconductor substrate 19a on the side opposite to the epitaxial layer 20. Herein, the material of the passivations 22a and 22b may be a photosensitivity resist or a silicon oxide film, but a material having resistance against a later-described semiconductor etching process in the lens formation has to be selected. Moreover, it is effective to make the passivation 22a have a curved shape by interferential photolithography or the like so that the passivation has a lens shape when subjected to semiconductor etching.

Next, as shown in FIG. 2D, the lenses 16a are formed on the semiconductor substrate 19a by the semiconductor etching process, thereby completing the laser diode array 17. The method of the semiconductor etching is also not particularly described, but the lenses can be formed by, for example, dry etching using plasma and a gas, wet etching using a chemical agent, or a combination of both of them.

An example of the fabrication method of the laser diode array 17 has been described herein. However, the photo diode array 18, which is another constituent part of the optical waveguide module of the present invention, can also be fabricated by the procedure similar to that described above.

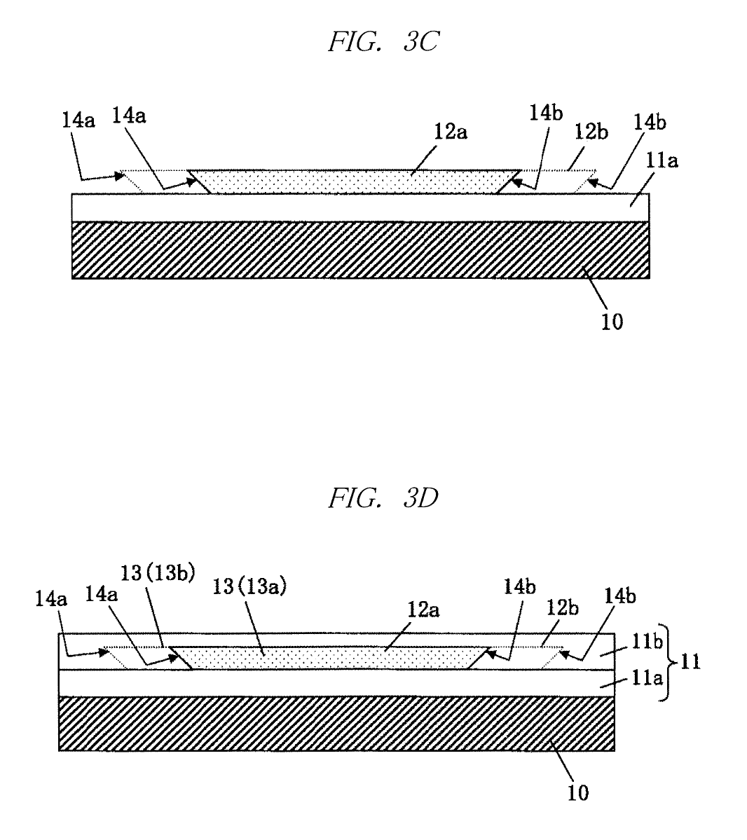

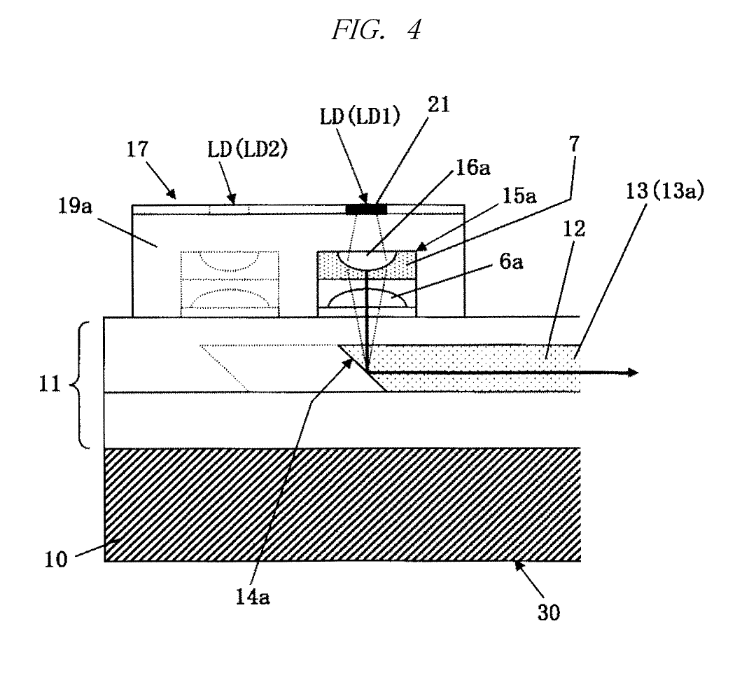

FIG. 3A to FIG. 3D are cross-sectional views showing manufacturing steps of the optical waveguide substrate incorporated in the optical waveguide module according to the first embodiment of the present invention (drawings describing an example of the fabrication procedure of the optical waveguide substrate). The present invention can be applied to both of a single waveguide and arrayed waveguides, and the fabrication procedures both of them are the same. The drawings used in the description herein show the case of the arrayed waveguides.

FIG. 3A is a drawing showing the state in which a cladding layer 11a is formed on the substrate 10 by application or pasting. For example, glass epoxy which is generally used in a printed circuit board is used as the material of the substrate 10. Also, a photosensitive polymer material which has good affinity with the processes of the printed circuit board compared with a quartz based material and others and can be easily fabricated by lithography is suitably used as the material of the cladding layer 11a.

Next, as shown in FIG. 3B, core patterns 12a and 12b on the upper surface of the cladding layer 11a are patterned and formed into cuboidal shapes by photolithography. A photosensitive polymer material similar to that of the cladding layer 11a is suitably used as the material of the core patterns 12a and 12b.

Next, as shown in FIG. 3C, the taper-shaped mirror parts 14a and 14b are formed at both end parts of the core patterns 12a and 12b, respectively. In the fabrication of the mirror parts 14a and 14b, a method such as physical processing by dicing or laser or tilted photolithography can be used. Furthermore, the surface of each of the mirror parts 14a and 14b may have the structure provided with an air wall and utilizing the total reflection caused by the difference in refractive index between air and the core or may be coated with a metal such as Au by vapor deposition or coating in order to reflect light by higher efficiency.

Next, as shown in FIG. 3D, the core patterns 12a and 12b are covered with a cladding layer 11b, thereby completing the optical waveguide substrate 30 provided with the optical waveguide array having the plurality of optical waveguides 13 (13a, 13b) surrounded by the cladding layer 11 (11a, 11b) and formed of the cores (core patterns 12a, 12b) made of the material having a refractive index higher than that of the cladding layer 11. An example of the fabrication method of the optical waveguide substrate 30 provided with a single-layer optical waveguide array has been described herein. However, also in the case in which multiple layers of the same optical waveguide arrays are stacked, the arrays can be fabricated by repeatedly carrying out the procedure of FIG. 3A to FIG. 3D described above.

Furthermore, when the convex members (6a, 6b) having the convex lens function are attached by a method such as adhesion in the state of FIG. 3D, the optical waveguide substrate 30 having the convex steps as shown in FIG. 1C is realized.

As described above, according to the present first embodiment, the laser diode array 17 provided with the lenses 16a on the same semiconductor substrate 19a and the photo diode array 18 provided with the lenses 16b on the same semiconductor substrate 19b are placed on the mirror parts 14a on the first side of the optical waveguide array and on the mirror parts 14b on the second side of the optical waveguide array, respectively, transmission/reception of light between the laser diodes LD of the laser diode array 17 and the optical waveguides 13 (cores 12) of the optical waveguide array is carried out via the lenses 16a provided in the semiconductor substrate 19a of the laser diodes LD, the convex members 6a having the convex lens function provided on the cladding layer 11 of the optical waveguide substrate 30, and the mirror parts 14a of the optical waveguides 13, and transmission/reception of light between the photo diodes PD of the photo diode array 18 and the optical waveguides 13 (cores 12) of the optical waveguide array is carried out via the lenses 16b provided in the semiconductor substrate 19b of the photo diodes PD, the convex members 6b having the convex lens function provided on the cladding layer 11 of the optical waveguide substrate 30, and the mirror parts 14b of the optical waveguides 13. As a result, the optical connection loss caused by diffusion of the beam of the light emitted from the laser diodes LD or the optical waveguides 13 can be suppressed without the need of mounting optical components between the optical waveguides 13 and photonic devices (laser diodes LD, photo diodes PD).

Furthermore, in the fabrication process of the optical element arrays (laser diode array 17, photo diode array 18), the lens (16a, 16b) can be fabricated in the same semiconductor substrate (19a, 19b) as that of the optical element array (laser diode array 17, photo diode array 18). Therefore, increase in the number of parts and fabrication steps and yield deterioration can be avoided.

Also, the convex member 6a having the convex step, which can be mated with the concave part 15a of the laser diode LD of the laser diode array 17, is provided on the cladding layer 11 of the optical waveguide substrate 30 so as to be planarly overlapped with the mirror part 14a on the first end side of the optical waveguide 13 (in other words, so as to be opposed to the mirror part 14a), and in the optical connection between the mirror part 14a on the first end side of the optical waveguide 13 of the optical waveguide substrate 30 and the laser diode LD of the laser diode array 17, the positioning of the laser diode LD and the mirror part 14a on the first end side of the optical waveguide 13 is carried out by mating the convex member 6a with the concave part 15a of the laser diode LD. Therefore, highly accurate mounting of the laser diode array 17 (laser diodes LD) can be simply realized.

Similarly, the convex member 6b having the convex step, which can be mated with the concave part 15b of the photo diode PD of the photo diode array 18, is provided on the cladding layer 11 of the optical waveguide substrate 30 so as to be planarly overlapped with the mirror part 14b on the second end side of the optical waveguide 13 (in other words, so as to be opposed to the mirror part 14b), and in the optical connection between the mirror part 14b on the second end side of the optical waveguide 13 of the optical waveguide substrate 30 and the photo diode PD of the laser diode array 18, the positioning of the photo diode PD and the mirror part 14b on the second end side of the optical waveguide 13 is carried out by mating the convex member 6b with the concave part 15b of the photo diode PD. Therefore, highly accurate mounting of the photo diode array 18 (photo diodes PD) can be simply realized.

Further, since the laser diode array 17 (laser diodes LD) and the photo diode array 18 (photo diodes PD) can be highly accurately mounted, the diodes and the waveguides can be coupled to each other with low loss. Therefore, the optical waveguide module capable of realizing efficient high-quality optical transmission with small power consumption can be provided.

Furthermore, since each of the convex members 6a and 6b is provided with the convex lens function, the lens 16a of the laser diode LD and the convex member 6a of the optical waveguide substrate 30 constitute the two-lens optical system, and the lens 16b of the photo diode PD and the convex member 6b of the optical waveguide 30 constitute the two-lens optical system. Since diffusion of light can be suppressed in the two-lens optical systems, the lateral displacement margin of the optical elements (laser diodes LD, photo diodes PD) with respect to the planar direction of the optical waveguide substrate 30 can be ensured, which is effective to passive optical element mounting.

In the present embodiment, the case in which the plurality of convex members 6a and 6b are provided for the respective mirror parts on the first end side and the second end side (14a, 14b) of the plurality of optical waveguides 13, in other words, the plurality of convex members 6a are provided so as to correspond to the number of the laser diodes LD of the laser diode array 17, and the plurality of convex members 6b are provided so as to correspond to the number of the photo diodes PD of the photo diode array 18 has been described. However, the convex members 6a and 6b are not necessarily provided so as to correspond to all of the mirror parts (14a, 14b).

For example, in the case in which the plurality of optical waveguides 13 are disposed in parallel like the present embodiment, the convex members 6a and 6b may be provided so as to correspond to the mirror parts (14a, 14b) of at least two optical waveguides 13.

However, in the case in which three or more optical waveguides 13 are disposed in parallel, it is desired that the convex members (6a, 6b) are provided so that at least one or more of the optical waveguide not serving as the installation target of the convex members (6a, 6b) are disposed between the two optical waveguides 13 serving as the installation targets of the convex members (6a, 6b).

In the case in which three or more optical waveguides 13 are disposed in parallel, it is desired that two of the optical waveguides 13 positioned on both sides of the array composed of the three or more optical waveguides 13 serve as the installation targets of the convex members (6a, 6b) and the convex members (6a, 6b) are provided so as to correspond to the two optical waveguides 13.

FIG. 4 is a cross-sectional view showing part of an optical waveguide module, which is a modification example of the first embodiment of the present invention, so as to correspond to the part of FIG. 1C.

In the present modification example, in order to protect the lens 16a formed in the concave part 15a of the laser diode LD of the laser diode array 17, the lens 16a is covered with a passivation 7 formed in the concave part 15a.

In the state in which the convex member 6a is mated with the concave part 15a of the laser diode LD, the convex member 6a is distant from the passivation 7 in the concave part 15a. More specifically, in order to avoid contact with the passivation 7 in the concave part 15a, the convex member 6a is formed to have a height smaller than the depth from the mounting surface on the concave part 15a side of the laser diode LD to the passivation 9 in the concave part 15a. The passivation 7 is made of a material such as an optical transparency resin having a transmittance of at least 10% or more with respect to the optical emission wavelength of the laser diode LD.

Although it is not shown in the drawing, similar to the laser diode LD, the lens 16b may also be covered with a passivation formed in the concave part 15b in order to protect the lens 16b formed in the concave part 15b of the photo diode PD of the photo diode array 18. Also in this case, in the state in which the convex member 6b is mated with the concave part 15b of the photo diode PD, the convex member 6b is distant from the passivation in the concave part 15b.

Also in this modification example, the effects similar to those of the above-described first embodiment can be obtained.

### Second Embodiment

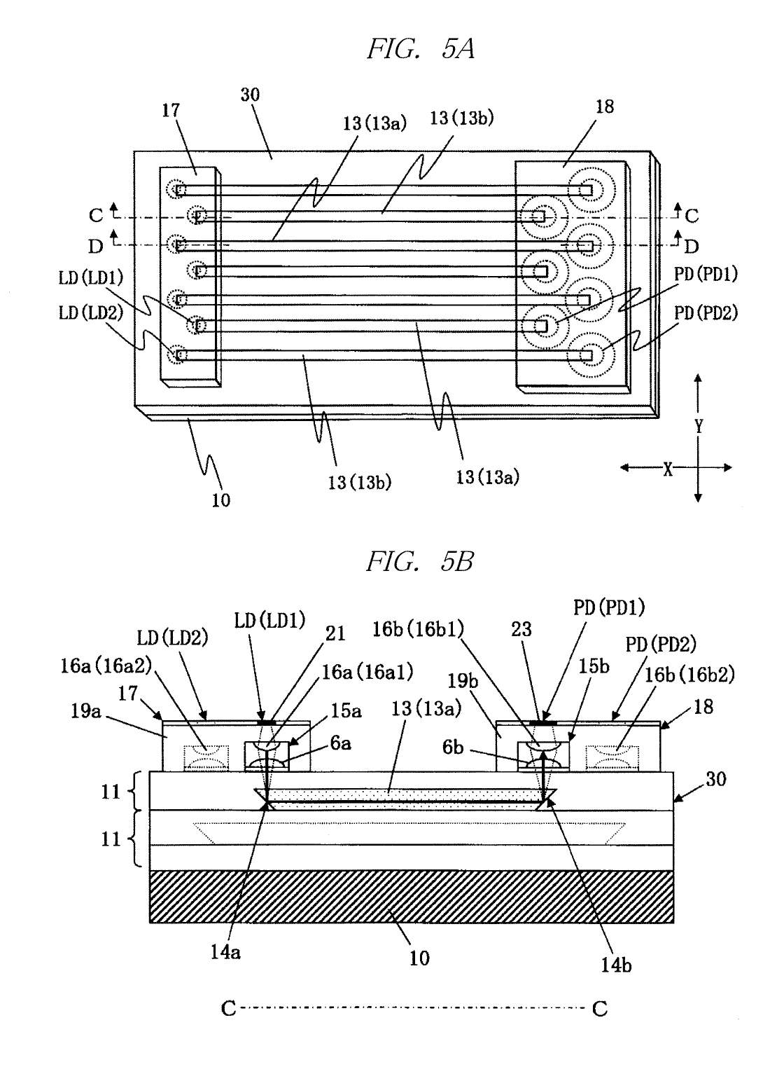

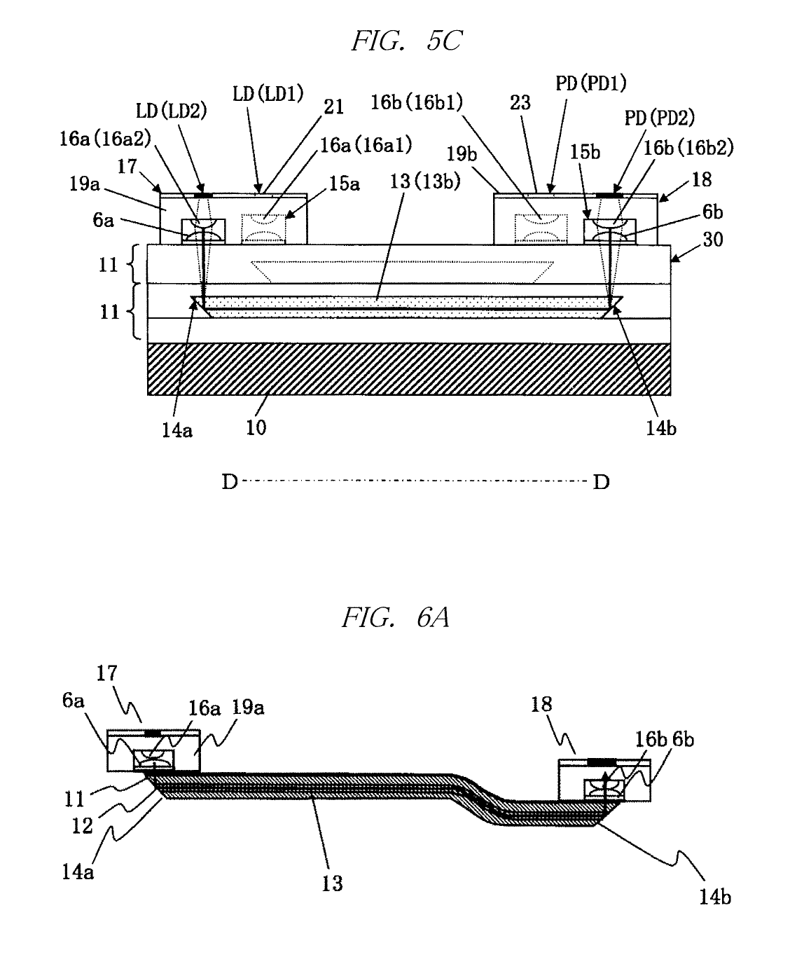

FIG. 5A to FIG. 5C are drawings relating to an optical waveguide module according to the second embodiment of the present invention, in which

FIG. 5A is a plan view (top view) showing a schematic configuration of the optical waveguide module,

FIG. 5B is a cross-sectional view showing the cross-sectional structure taken along the C-C line of FIG. 5A, and

FIG. 5C is a cross-sectional view showing the cross-sectional structure taken along the D-D line of FIG. 5A.

The optical waveguide module of the present second embodiment basically has a configuration similar to that of the above-described first embodiment and has a difference in configuration described below.

In the above-described first embodiment, the optical waveguide substrate 30 having the single-layer optical waveguide array has been described.

On the other hand, as shown in FIG. 5A to FIG. 5C, the optical waveguide substrate 30 of the present second embodiment has a multilayer structure in which the optical waveguides 13a and the optical waveguides 13b whose optical path has a longer length than that of the optical waveguide 13a are formed in different layers. In the present embodiment, the optical waveguides 13b are formed in a first layer, the optical waveguides 13a are formed in a second layer which is a layer above the first layer, and as shown in FIG. 5A, the optical waveguides 13a and 13b are disposed in the same manner as those of the above-described first embodiment (see FIG. 1B) when planarly viewed.

In the optical waveguide module of the present embodiment, as shown in FIG. 5B, an optical signal emitted from the laser diode LD1 of the first column of the laser diode array 17 in the direction perpendicular to the substrate is focused by the lens 16a (16a1) formed in the semiconductor substrate 19a, is further focused by the convex member 6a having the convex lens function, is subjected to optical path conversion in the direction horizontal to the substrate via the mirror part 14a on the first end side of the optical waveguide 13a positioned in the upper layer, and is propagated in the optical waveguide 13a. Thereafter, the optical signal is subjected to optical path conversion again in the direction perpendicular to the substrate by the mirror part 14b on the second end side of the optical waveguide 13a, is focused by the convex member 6b having the convex lens function, and then emitted therefrom. The emitted optical signal is focused by the lens 16b (16b1) formed in the semiconductor substrate 19b, is then subjected to photoelectric conversion in the photo diode PD (PD1) of the first column of the photo diode array 18, and is output as an electric signal.

As shown in FIG. 5C, similar to the description above, an optical signal emitted in the direction perpendicular to the substrate from the laser diode LD2 of the second column of the laser diode array 17 is focused by the lens 16a (16a2) formed in the semiconductor substrate 19a, is further focused by the convex member 6a having the convex lens function, is subjected to optical path conversion in the direction horizontal to the substrate via the mirror part 14a on the first end side of the optical waveguide 13b positioned in the lower layer, and is propagated in the optical waveguide 13b. Thereafter, the optical signal is subjected to optical path conversion again in the direction perpendicular to the substrate by the mirror part 14b on the second end side of the optical waveguide 13b, is focused by the convex member 6b having the convex lens function, and then emitted therefrom. The emitted optical signal is focused by the lens 16b (16b2) formed in the semiconductor substrate 19b, is then subjected to photoelectric conversion in the photo diode PD (PD2) of the second column of the photo diode array 18, and is output as an electric signal.

In this structure, as shown in FIG. 5B and FIG. 5C, the lens 16a1 of the laser diode LD1 of the first column of the laser diode array 17 and the lens 16a2 of the laser diode LD2 of the second column of the laser diode array 17 have mutually different distances to the respective mirror parts 14a of the optical waveguides 13 (13a, 13b) connected optically. Therefore, the focal positions in accordance with the distances to the optical waveguides 13 (13a, 13b) are optimized by changing the curvature and the curvature radius of the respective lenses 16a1 and 16a2. Specifically, the curvature can be reduced by increasing the depth of the concave part 15a formed in the periphery of the lens 16a1 or 16a2, and the curvature radius can be increased by increasing the groove diameter.

Thus, since the lens 16a1 corresponding to the laser diode LD1 of the first column of the laser diode array 17 has a shorter distance to the mirror part 14a of the optical waveguide 13 (13a, 13b) compared with the lens 16a2 corresponding to the laser diode LD2 of the second column, the curvature and the curvature radius of the lens 16a1 are made smaller than those of the lens 16a2 by making the depth and the diameter of the concave part 15a corresponding to the laser diode LD1 of the first column deeper and smaller than those of the concave part 15a corresponding to the laser diode LD2 of the second column.

Similar to the description above, as shown in FIG. 5B and FIG. 5C, the lens 16b1 of the photo diode PD1 of the first column of the photo diode array 18 and the lens 16b2 of the photo diode PD2 of the second column of the photo diode array 18 have mutually different distances to the respective mirror parts 14b of the optical waveguides 13 (13a, 13b) connected optically. Therefore, the focal positions in accordance with the distances to the optical waveguides (13a, 13b) are optimized by changing the curvature and the curvature radius of the respective lenses 16b1 and 16b2. Specifically, the curvature can be reduced by increasing the depth of the concave part 15b formed in the periphery of the lens 16b1 or 16b2, and the curvature radius can be increased by increasing the groove diameter. Thus, since the lens 16b1 corresponding to the photo diode PD1 of the first column of the photo diode array 18 has a shorter distance to the mirror part 14b of the optical waveguide 13 (13a, 13b) compared with the lens 16b2 corresponding to the photo diode PD2 of the second column, the curvature and the curvature radius of the lens 16b1 are made smaller than those of the lens 16b2 by making the depth and the diameter of the concave part 15b corresponding to the photo diode PD1 of the first column deeper and smaller than those of the concave part 15b corresponding to the photo diode PD2 of the second column.

The curvature and the curvature radii of the lenses can be easily changed at one time by changing the pattern of the passivation for the semiconductor etching on the same semiconductor substrate.

In the configuration in which multiple layers of the optical waveguide arrays are stacked and optically connected to optical element arrays like in the structure described above, the density of the optical elements and the optical waveguides can be increased in a smaller area.

### Third Embodiment

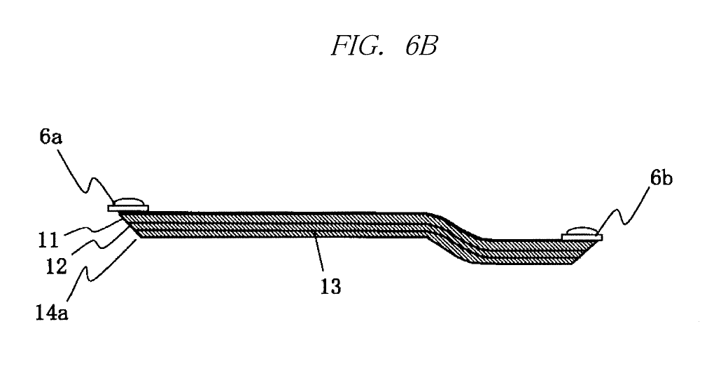

FIG. 6A and FIG. 6B are drawings relating to an optical waveguide module according to the third embodiment of the present invention, in which

FIG. 6A is a cross-sectional view showing a schematic configuration of the optical waveguide module, and

FIG. 6B is a cross-sectional view showing the state in which illustration of optical element arrays (laser diode array and photo diode array) in FIG. 6A is omitted.

Herein, an optical waveguide made of a material which can be bent at an arbitrary curvature and having flexibility is used for the part of the waveguide.

### Fourth Embodiment

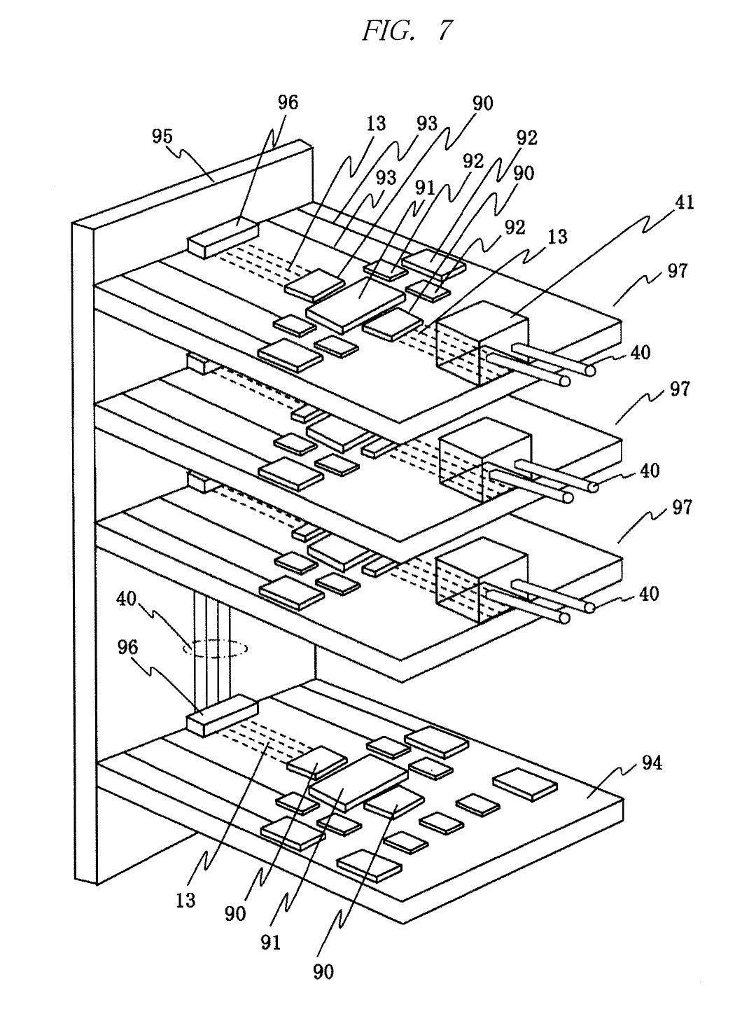

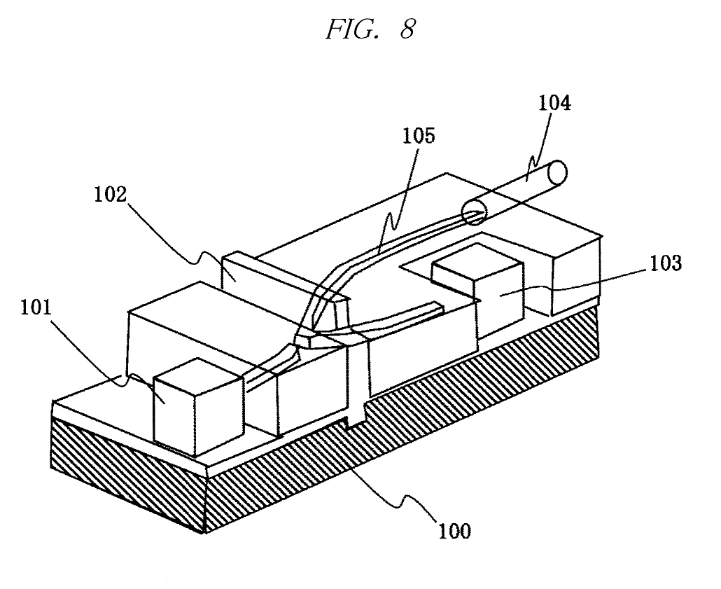

FIG. 7 is a drawing showing the overview of an opto-electronic hybrid circuit in which the optical waveguide modules of the present invention are applied according to the fourth embodiment of the present invention. Herein, the example in which the optical waveguide modules of the present invention described in the first and second embodiments are applied to daughter boards 97 connected to a backplane 95.

As shown in FIG. 7, an optical signal input from the front side of a board by, for example, function Ethernet connected to the outside of the substrate is converted to an electric signal by an optical element array 90 through the optical waveguide 13 via the fiber 40, the electric signal processed by an integrated circuit 92 is further converted to an optical signal by the optical element array 90, and is transmitted to an optical connector 96 on the backplane 95 side via the optical waveguide 13. Furthermore, the optical signals from the daughter boards 97 are collected to a switch card 94 via the fibers 40 and other of the backplane 95. Furthermore, the signals optically connected to the optical element arrays 90 via the optical waveguides 13 provided on the switch card 94 and processed by an integrated circuit 91 are input/output to and from the daughter boards 97 again via the optical element arrays 90.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

It is possible to provide an optical waveguide module, which serves as a terminal in transmission of high-speed optical signals transmitted/received between chips and boards with using optical waveguides as wiring media between devices or in a device such as a data processing device, satisfies highly-accurate and stable optical connection between optical elements and optical waveguides, and can be easily fabricated, and an opto-electronic hybrid circuit which carries out signal processing on a board by using the optical waveguide module.

### DESCRIPTION OF REFERENCE NUMERALS

6a, 6b: convex member
7, 9: passivation
11, 11a, 11b: cladding layer
12: core
12a, 12b: core pattern
13, 13a, 13b: optical waveguide
14a, 14b: mirror part
15a, 15b: concave part
16a, 16a1, 16a2, 16b, 16b1, 16b2: lens
17: laser diode array
18: photo diode array
19a, 19b: semiconductor substrate
20: epitaxial layer
21: light emitting part
22a, 22b: passivation
23: light receiving part
30: optical waveguide substrate
40: fiber
41, 96: optical connector
91, 92: integrated circuit
90: optical element array
94: switch card
95: backplane
97: daughter board

1. An optical waveguide having a core layer surrounded by a cladding layer, provided with a mirror part formed of a tapered surface on a first end side, and transmitting light when an optical element is mounted, the optical waveguide comprising:
a convex member provided on the cladding layer so as to be planarly overlapped with the mirror part,
wherein the convex member has a shape capable of being mated with a concave part of an optical element when the optical element having the concave part is mounted on a first surface of a semiconductor substrate.

2. The optical waveguide according to claim 1, wherein the optical waveguide is made of polymer.

3. The optical waveguide according to claim 2, wherein the convex member is made of the same material as the core layer.

4. An optical waveguide module comprising:
an optical waveguide surrounded by a cladding layer and provided with a mirror part formed of a tapered surface on a first end side;
an optical element having a concave part in a first surface of a semiconductor substrate; and
a convex member provided on the cladding layer so as to be planarly overlapped with the mirror part, wherein the convex member is mated with the concave part of the optical element.

5. An optical waveguide module comprising:
a plurality of optical waveguides each surrounded by a cladding layer and provided with a mirror part formed of a tapered surface on a first end side, the optical waveguides being disposed in parallel to each other;
an optical element array having a plurality of optical elements each having concave parts in a first surface of a semiconductor substrate and formed on the semiconductor substrate so as to correspond to the mirror parts of the plurality of optical waveguides; and
two convex members provided on the cladding layer so as to be planarly overlapped with each of the mirror parts of at least two of the optical waveguides among the plurality of optical waveguides,
wherein the two convex members are mated with the concave parts of the at least two optical elements among the plurality of optical elements.

6. The optical waveguide module according to claim 4, wherein the convex member has a convex lens function.

7. The optical waveguide module according to claim 5, wherein the convex member has a convex lens function.

8. The optical waveguide module according to claim 6, wherein the optical element has a lens at a bottom surface of the concave part, and the lens is distant from the convex member.

9. The optical waveguide module according to claim 7, wherein the optical element has a lens at a bottom surface of the concave part, and
the lens is distant from the convex member.

10. The optical waveguide module according to claim 4, wherein the optical element is a laser diode having a lens provided at a bottom surface of the concave part and a light emitting part provided on a second surface side opposite to the first surface of the semiconductor substrate so as to be opposed to the lens.

11. The optical waveguide module according to claim 5, wherein the optical element is a laser diode having a lens provided at a bottom surface of the concave part and a light emitting part provided on a second surface side opposite to the first surface of the semiconductor substrate so as to be opposed to the lens.

12. The optical waveguide module according to claim 4, wherein the optical element is a photo diode having a lens provided at a bottom surface of the concave part and a light receiving part provided on a second surface side opposite to the first surface of the semiconductor substrate so as to be opposed to the lens.

13. The optical waveguide module according to claim 5, wherein the optical element is a photo diode having a lens provided at a bottom surface of the concave part and a light receiving part provided on a second surface side opposite to the first surface of the semiconductor substrate so as to be opposed to the lens.

14. The optical waveguide module according to claim 5, wherein the number of the plurality of optical waveguides is three or more, and
at least one or more of the optical waveguides are disposed between two of the optical waveguides corresponding to the two convex members.

15. The optical waveguide module according to claim 6, wherein the number of the plurality of optical waveguides is three or more, and
the two convex members correspond to the mirror parts of the two optical waveguides positioned on both sides of an array made up of the three or more optical waveguides.

16. The optical waveguide module according to claim 7, wherein the number of the plurality of optical waveguides is three or more, and
the two convex members correspond to the mirror parts of the two optical waveguides positioned on both sides of an array made up of the three or more optical waveguides.

17. (canceled)

18. (canceled)

19. (canceled)
